(19) United States
(12) Patent Application Publication
(10) Pub. No.: US 2006/0121420 A1
(43) Pub. Date: Jun. 8, 2006

(54) Pilot seat positioning device

(76) Inventors: Michael Athanas, Hyde Park, NY (US); Fred Justiniano, Bronx, NY (US); Alred Montleone, Clintondale, NY (US)

Correspondence Address: JOHN MAIER, III, 660 AARON COURT, KINGSTON, NY, 12401, US

(21) Appl. No.: 10/991,731

(22) Filed: Nov. 18, 2004

(51) Int. Cl. G09B 19/16

(52) U.S. Cl. 434/31

(57) ABSTRACT

The Pilot Seat Positioning Device has a frame which includes a base frame, a lower frame, and an upper frame and four vertical posts extending between the lower frame and the upper frame. Four pistons are located between the base frame. An upper journal is mounted on the upper frame. A lower journal is mounted on the lower frame. An outer ring is mounted to rotate on the upper journal and the lower journal by an upper motor and lower motor. A support ring is mounted to rotate on the outer ring and the support ring is located generally at right angles to the outer ring. The support ring has a support ring gear mounted on it. A support shroud covers the support ring gear. An upper support motor and a lower support motor are mounted on the support shroud. An upper support idler gear and a lower support idler are mounted on the support shroud. An inner ring is mounted to rotate in the outer ring within the support ring. An upper inner union and a lower inner union are mounted on opposite sides of the inner ring. The inner ring includes an inner ring gear mounted on the outer periphery of the inner ring and an inner shroud covering the inner ring and inner ring gear. An upper inner motor and an upper inner idler gear and a lower inner motor and a lower inner idler gear are mounted on the inner shroud. A seat platform extends across the inner ring and is mounted on the inner ring. A seat support member is located generally at right angles to the seat platform and in the same plane as the seat platform. The seat support member is mounted to rotate on the support ring. A pilot seat is mounted on the seat support member and across the support platform. A hydraulic system and an electrical system controls the flow of hydraulic fluid.

### FIELD OF THE INVENTION

This invention relates to positioning a pilot seat and more specifically to a pilot seat positioning device that permits the pilot seat to be placed in any position that an aircraft can assume when flying and to a Pilot Seat Positioning Device that can be utilized as a Pilot Seat Positioning Device in a flight simulator and also as a pilot seat for remote operation of an actual aircraft.

### PRIOR ART

Pilot seats for flight simulators have been traditionally retained in a fixed position. The Mohan et. al. patent, U.S. Pat. No. 4,512,745 teaches a flight simulator in which the pilot sits in a fixed seat. Likewise, McGraw, et. al. U.S. Pat. No. 4,162,582 also provides a seat for a pilot that is fixed but provides a rotatable sphere, which provides complete visual coverage in all directions. As with Mohan, et. al., the pilot remains in a fixed position and the simulation of flight is created by the visual portrayal seen by the pilot.

It has always been accepted that a military plane has a pilot in the plane. This subjects the pilot to danger and requires that each plane be constructed, obviously at greater cost, to protect the pilot. Therefore, military planes which could be operated remotely would be both economical and even more importantly, life saving. Such remote operation is feasible. A seat which positions the pilot in the same position as the pilot would experience if in an aircraft, provides the pilot with the same sensations as if actually in the aircraft and a camera permits the pilot to see what a pilot in the aircraft would see.

### OBJECTS

The objects of this invention are as shown:

1. To provide a pilot seat which can place the pilot in any position.

2. To provide a pilot seat which can be used both as a pilot trainer and as a pilot seat for remote operation of a plane.

3. To provide a pilot seat which is dependable and cost effective.

### SUMMARY OF THE INVENTION

A Pilot Seat Positioning Device is provided that has a frame including an upper frame and a lower frame. An upper journal is mounted on the upper frame and a lower journal is located on the lower frame. An outer ring rotates on the upper journal and the lower journal and the lower journal. A support ring rotates on the outer ring but the support ring is positioned generally at right angles to the outer ring. An inner ring rotates on the outer ring within the support ring. Means are provided for rotating both the support ring and the inner ring. A seat platform extends across the inner ring and is mounted on the inner ring. A seat support member is mounted in the support platform. The seat support member rotates in the support ring. A pilot seat is mounted on the seat support member and across the support member.

### DESCRIPTION OF THE DRAWINGS

FIG. 1A is a pictorial view of the pilot seat mounted in a plurality of rings which are supported within a frame.

FIG. 1B is a pictorial view of the frame without the rings.

FIG. 1C is a cross sectional view of the lower journal.

FIG. 1D is a cross sectional view of the upper journal.

FIG. 2A is a front elevation of the upper support gears and the support ring gear of the support ring.

FIG. 2B is a front elevation of the lower support gear and the lower support idler gear on the support ring.

FIG. 3A is a view similar to FIG. 2A but of the upper inner gear and inner ring gear.

FIG. 3B is a view similar to FIG. 2B but of the lower ring motor and lower idler gear and inner ring gear.

FIG. 4 is a cross sectional view of the support ring gear on the support ring and the support motor.

FIG. 5 is a plan view of the pilot seat within the inner ring and the outer ring.

FIG. 6A is a perspective view of the inner cylinder of a hydraulic union.

FIG. 6B is a cross sectional view of a hydraulic union.

FIG. 7 is a schematic diagram of the hydraulic system.

FIG. 8 is a schematic diagram of the electrical system.

DESCRIPTION OF THE NUMERALS

| NUMERAL | DESCRIPTION |
|---|---|
| 15 | FRAME |
| 17 | BASE FRAME |
| 19 | LOWER FRAME |
| 21 | UPPER FRAME |
| 25 | FOUR VERTICAL POINTS |
| 27 | FOUR PISTONS |
| 29 | PILOT SEAT |
| 31 | SERIES OF RINGS |
| 33 | UPPER CROSS MEMBER |
| 37 | LOWER CROSS MEMBER |
| 39 | UPPER JOURNAL |
| 41 | LOWER JOURNAL |
| 42 | COMMON CENTERLINE |
| 43 | OUTER RING |
| 47 | UPPER UNION |
| 48 | UPPER CONNECTOR |
| 49 | LOWER UNION |
| 50 | LOWER CONNECTOR |
| 51 | UPPER BEVEL GEAR |
| 53 | LOWER BEVEL GEAR |
| 55 | LOWER CASING |
| 57 | UPPER CASING |
| 61 | UPPER MOTOR |
| 63 | UPPER MOTOR GEAR |
| 65 | LOWER MOTOR |
| 67 | LOWER MOTOR GEAR |
| 71 | SEMICIRCULAR UPPER CUT OUT |
| 75 | SEMICIRCULAR LOWER CUT OUT |
| 77 | UPPER SUPPORT MOTOR |
| 81 | LOWER SUPPORT MOTOR |
| 82 | UNION (EXAMPLE) |
| 83 | CYLINDER |
| 84 | LONGITUDINAL HOLES |
| 85 | INDENTED RINGS |
| 86 | HOUSING |
| 89 | UPPER INNER UNION |
| 91 | UPPER INNER MOTOR |
| 95 | LOWER INNER UNION |
| 96 | LOWER INNER HYDRAULIC UNION |
| 97 | LOWER INNER MOTOR |
| 99 | HYDRAULIC POWER PACK |
| 101 | SUPPORT RING |
| 103 | SUPPORT GEAR |
| 105 | OUTER PERIPHERY |
| 107 | SHROUD |
| 113 | LOWER SUPPORT GEAR |
| 115 | UPPER SUPPORT GEAR |
| 117 | UPPER SUPPORT IDLER GEAR |
| 119 | LOWER SUPPORT IDLER GEAR |
| 121 | INNER ASSEMBLY RING |
| 123 | BEARINGS |
| 124 | SEAT PLATFORM |
| 126 | SEAT SUPPORT MEMBER |
| 129 | INNER RING |
| 131 | INNER RING GEAR |
| 133 | INNER SHROUD |
| 137 | UPPER INNER MOTOR GEAR |
| 139 | LOWER INNER MOTOR GEAR |
| 141 | UPPER INNER IDLER GEAR |
| 143 | LOWER INNER IDLER GEAR |
| 145 | HYDRAULIC LINES |
| 149 | FIRST UPPER UNION LINE |
| 150 | SECOND UPPER UNION LINE |
| 151 | THIRD UPPER UNION LINE |
| 152 | FOURTH UPPER UNION LINE |
| 153 | FIRST LOWER UNION LINE |
| 154 | SECOND LOWER UNION LINE |
| 155 | THIRD LOWER UNION LINE |
| 156 | FOURTH LOWER UNION LINE |
| 157 | FIRST UPPER SUPPORT MOTOR LINE |
| 159 | SECOND SUPPORT MOTOR LINE |
| 161 | SECOND LOWER SUPPORT |
| | MOTOR LINE |
| 163 | SECOND LOWER SUPPORT |
| | MOTOR LINE |
| 165 | FIRST UPPER INNER MOTOR LINE |
| 167 | SECOND UPPER INNER MOTOR LINE |
| 169 | FIRST LOWER INNER MOTOR LINE |
| 171 | SECOND LOWER INNER MOTOR LINE |
| 173 | FIRST UPPER MOTOR LINE |
| 175 | SECOND UPPER MOTOR LINE |
| 177 | FIRST LOWER MOTOR LINE |
| 179 | SECOND LOWER MOTOR LINE |
| 181 | FIRST PISTON HYDRAULIC LINE |
| 182 | SECOND PISTON HYDRAULIC LINE |
| 183 | CENTRAL PROCESSING UNIT |
| 185 | AUDIO SYSTEM |
| 187 | VIDEO SYSTEM |
| 189 | PISTON CIRCUIT |
| 191 | PISTON AMPLIFIER |
| 193 | PISTON SOLENOID VALVES |
| 195 | MOTOR CIRCUIT |
| 197 | UPPER AND LOWER |
| | MOTOR AMPLIFIER |
| 199 | UPPER AND LOWER |
| | MOTOR SOLENOID |
| 201 | SUPPORT CIRCUIT |
| 203 | SUPPORT AMPLIFIER |
| 205 | SUPPORT SOLENOID VALVE |
| 207 | INNER CIRCUIT |
| 209 | INNER AMPLIFIER |
| 211 | INNER SOLENOID |
| 213 | PILOT INPUT SYSTEM |
| 215 | GENERAL INPUT SYSTEM |

### DETAILED DESCRIPTION OF THE PREFERRED EMBODIMENT

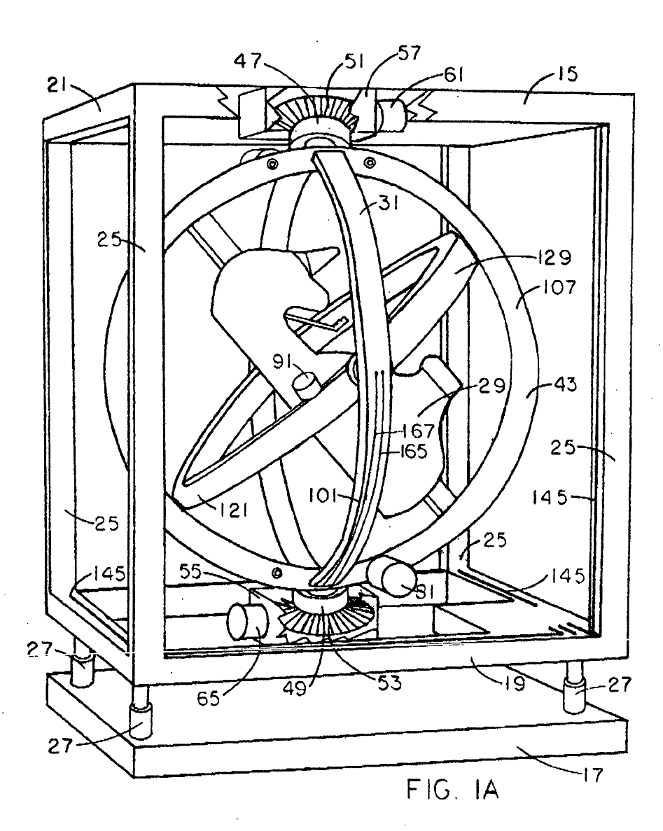

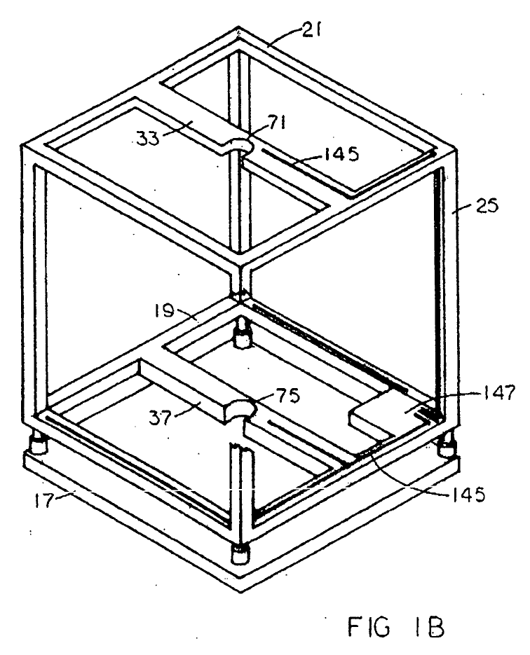

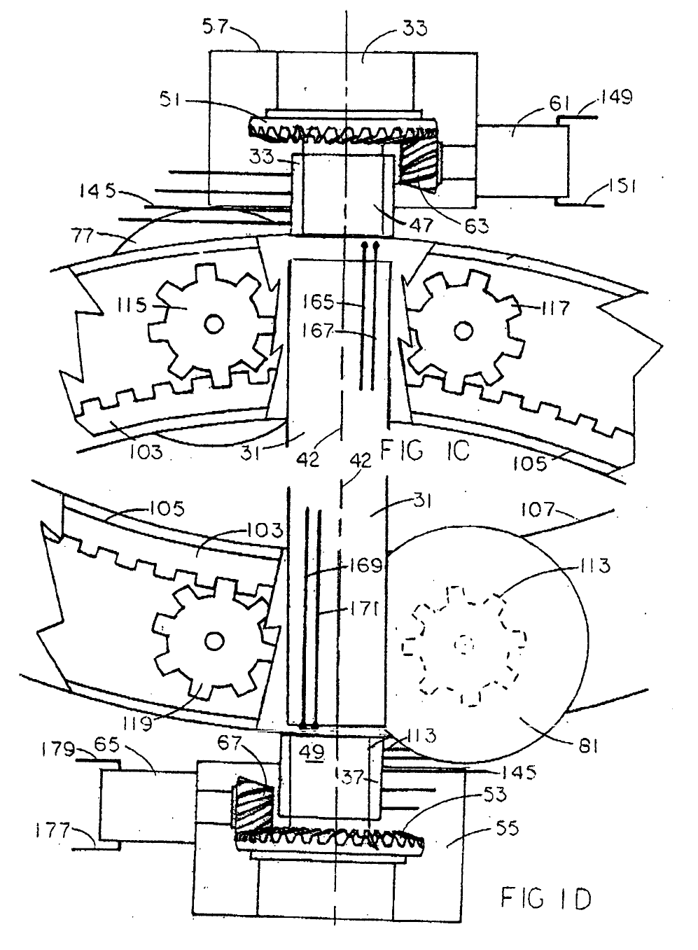

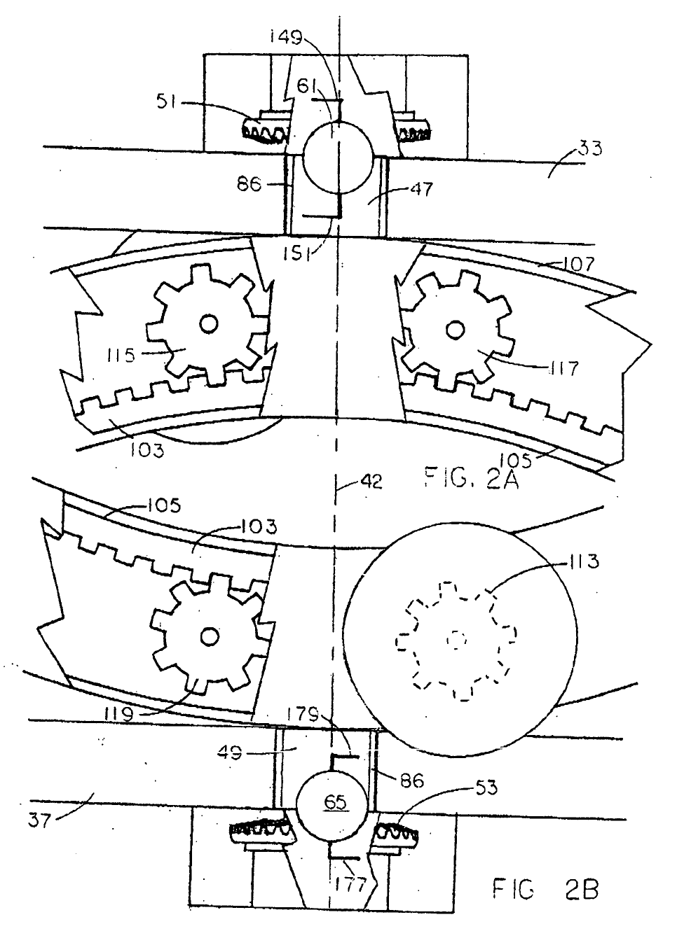

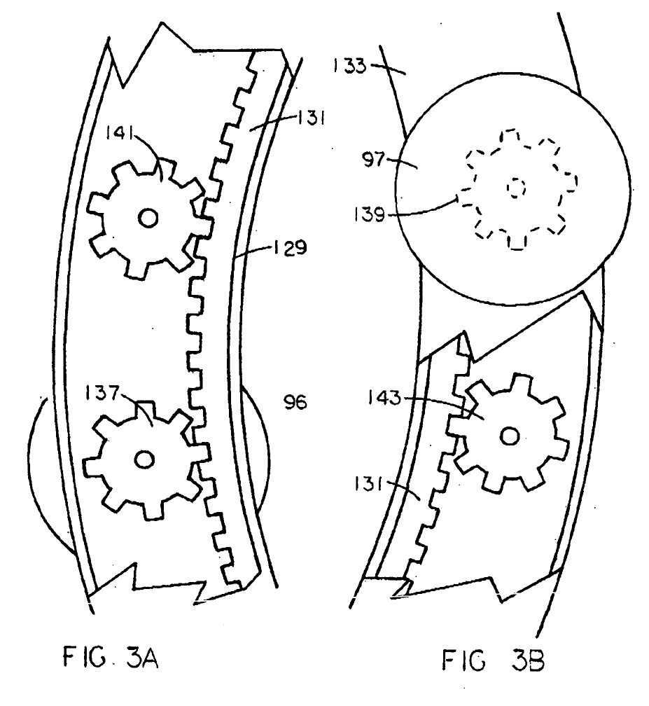

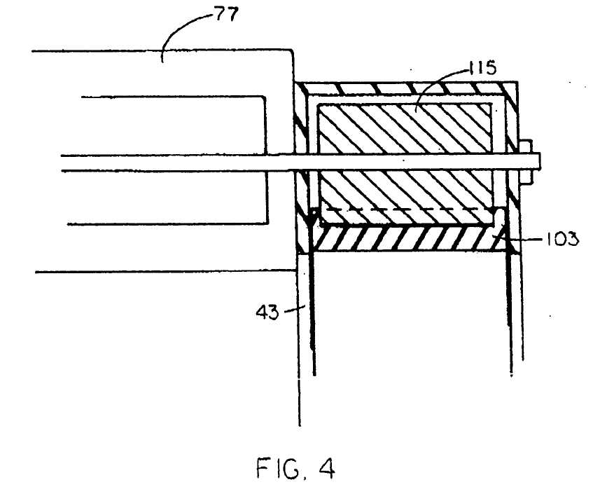

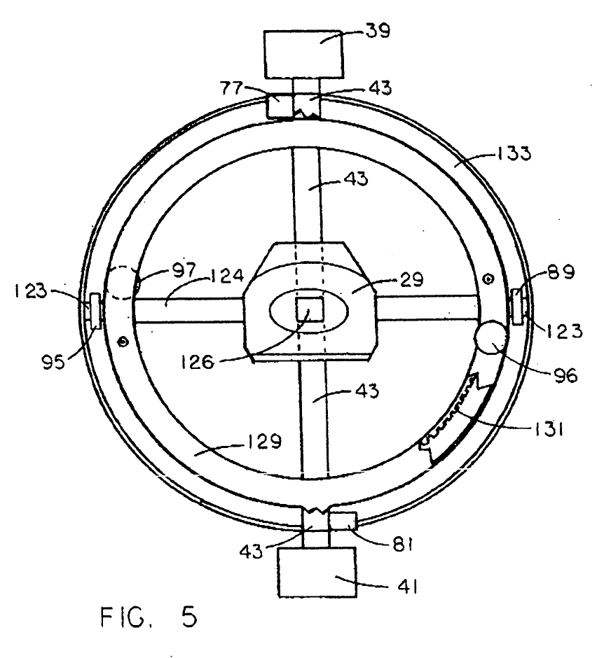

Referring now to FIG. 1A, the Pilot Seat Positioning Seat is shown mounted within a frame 15. The frame 15 has a base frame 17, a lower frame 19 and an upper frame 21 as well as four vertical posts 25. The lower frame 19 is located just above the base frame 17. Both the base frame 17 and the lower frame 19 are rectangular having four corners. The upper frame 21 and the base frame 17 and the lower frame 19 are generally identical in size and shape. At each of the four corners of the base frame 17 and the lower frame 19 are four pistons 27 which support the lower frame 19. The four pistons 27, when activated, produce rumble and tip. At each of the four corners of the lower frame 19 and the upper frame 21 are one of the vertical posts 25. This produces the frame 15 in which a pilot seat 29 is mounted within a series of rings 31. The rings 31 are all circular. The Pilot Seat 29 is designed generally to be a reproduction of the fight deck of an airplane including all instrumentation.

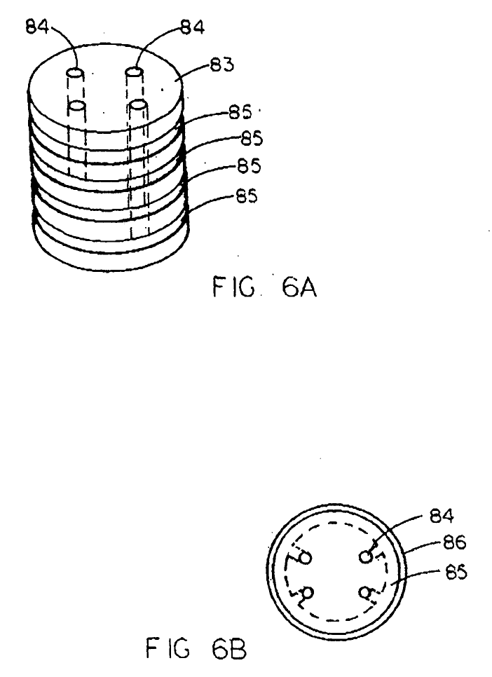

The upper frame 21 (FIG. 1B) has an upper cross member 23 and the lower frame 19 has a lower cross member 37. An upper journal 39 (FIG. 1A) is mounted generally in the center area of the upper frame 19. A lower journal 41 is mounted generally in the center area of the lower frame 19. The upper journal 39 and the lower journal 41 have a common centerline 42. An outer ring 43 rotates in either direction for a complete circle on the upper journal 39 and the lower journal 41 for pitch control. The upper journal 39 (FIG. 1D) and the lower journal 41 (FIG. 1C) each contain an upper union 47 with an upper connection 48 and a lower union 49 with a lower connector 50 respectively. The upper journal 39 and the lower journal 41 also each contain an upper bevel gear 51 and a lower bevel gear 53. The upper union 47 and the lower union 49 are rotary hydraulic unions as shown in FIGS. 6A and 6B. The lower bevel gear 53 is mounted in a lower casing 55. The upper bevel gear 51 is mounted in an upper casing 57.

An upper motor 61, has a shaft with an upper motor gear 63 attached to which it engages and drives the upper bevel gear 51. A lower motor 65 has a shaft with a lower bevel motor gear 67 attached to it which engages and drives the lower bevel gear 53.

The upper union 47 fits into an upper semicircular cut out 71 (FIG. 1A) in the upper cross member 33 in the upper frame 21. Similarly, the lower union 49 fits into a lower semicircular cut out 75 (FIG. 1A) in the lower cross member 37 in the lower frame 19.

The upper union 47 and the lower union 49 are essential to permit the passage of hydraulic fluid to an upper support motor 77 and a lower support motor 81 and to other hydraulic functions as will be explained hereinafter. The upper support motor 77 and the lower support motor 61 face in appropriate directions. The upper union 47 mounted in the upper journal 39 and the lower union 49 (similar to the housing 85 described hereinafter) in the lower journal 41 each has an inner cylinder (similar to the cylinder 83 described hereinafter) which rotates and a union housing which remains fixed. Unions for the passage if hydraulic fluid are known but a brief description of their function for clarity is advisable.

A general example of a union 82 is shown in FIGS. 6A and 6B. A cylinder 83 which rotates has a series of longitudinal holes 84 and indented rings 85 about the periphery of the cylinder 83. Each longitudinal hole 84 connects to a separate indented ring 85. The cylinder 83 rotates and this can follow a moving component while a housing 86 remains fixed. Hydraulic fluid can therefore be supplied to and from to the housing 86 from a fixed location and supplied to a moving component. The union 82 generally shown in FIG. 6A and FIG. 6B is a four line union but unions with a lesser and a greater number of lines are similarly constructed. The union 82 is an example of a union to explain briefly the functioning of the upper union 77 and lower union 81 and other unions subsequently to be discussed. Other possible designs for a union 82, which may exist, could also be used.

The upper union 47 is a rotating hydraulic union and besides supplying hydraulic fluid to the upper motor 61 also supplies, through an upper inner union 89, an upper inner motor 91. Similarly, the lower union 49, through a lower inner union 95 supplies hydraulic fluid to a lower inner motor 97. The upper inner union 89 and the lower inner union 95 have two lines and not four lines but generally function as does the union 82 which is shown on FIG. 6A and FIG. 6B. Both the upper union 47 and the lower union 53 have four lines, two of which flow in and out of the inner unions 89, 95 and two of which flow in and out of the support motors 77, 81.

The upper bevel gear 51 is affixed to an upper union 47 and drives an inner cylinder of the upper union 47. The upper bevel gear 51 is located within the casing 57 which is secured to the frame 15. The upper bevel gear 51 is mounted on the outside end of the upper union 47 away from the frame 15. The upper motor 61 is mounted on the upper casing 57.

The lower bevel gear 53 is a mirror image of the upper bevel gear 51. The lower bevel gears 53 drives an inner cylinder of the lower union 49 which is generally as shown for the cylinder 83 and is mounted on the outside end of the lower union 49. The lower casing 55 encloses the lower bevel gear 53. The lower casing 53 is mounted on the lower frame 19. The lower motor 65 is mounted on the lower casing 53. The lower motor 65 has a shaft on which a lower motor gear 67 is mounted and which engages and drives the lower bevel gear 53.

It should be noted that since the upper motor 63 and the lower motor 65, both of which are hydraulic, remain in a fixed position. The hydraulic fluid which drives the upper motor 61 and the lower motor 65 is directly supplied from a hydraulic power pack 99 to the upper motor 61 and to the lower motor 65 and does not pass through either the lower union 49 or the upper union 47.

A support ring 101 is mounted on and extends from the outer ring 43 at the upper journal 39 and the lower journal 41 and is substantially at right angles to the outer ring 43 and rotates with the outer ring 43 when the outer ring 43 is rotated. However, the support ring 101 rotates in a complete circle within the outer ring 43. The support ring 101, which like the outer ring 43, is circular, has a slightly smaller diameter than the outer ring 43.

The support ring 101 has a support gear 103 located about its outer periphery 105. A shroud 107 covers the support gear 103. The shroud 107 is secured to the upper journal 39 and the lower journal 41 and rotates about the axis of the upper journal 39 and the lower journal 41. The support ring 101 is held in place by the shroud 107. The upper support motor 77, and the lower support motor 81, also hydraulic motors, rotate the support ring 101.

A lower support gear 113 is mounted on the shaft of the lower support motor 81. An upper support gear 115 is mounted on the shaft of an upper support motor 77. The upper support gear 115 and the lower support gear 113 both engage the support gear 103. The upper support gear 115 is paired with an upper support idler gear 117. The lower support 113 is paired with a lower support idler gear 119. The upper support idler gear 117 and the lower support idler gear 119 deter the support ring 101 from moving away from the upper support motor 77 and the lower support motor 81. The upper support gear 115 and upper idler gear 117 are equally spaced on opposite sides of the centerline 42 of the upper journal 39 and the lower journal 41 and on the opposite sides of the centerline 42 from the lower support gear 113 and lower support idler gear 119 which are equally spaced from the centerline 42 the same distance as the upper support gear 115 and the upper support idler gear 117.

An inner ring assembly 121 is supported by the pair of inner unions 89, 95 and is held generally centrally within the outer ring 43 and the support ring 101. A seat platform 124 extends generally across the diameter of the inner ring assembly 121. The seat platform 124 is secured to the inner ring assembly 121. The pilot seat 29 is affixed to the seat platform 124 but the pilot seat 29 is generally at right angles to the seat platform 124. The pilot seat 29 has a seat support member 126 which extends along the longitudinal axis of the pilot seat 29 and is located generally at the center of the seat platform 124 but in the same plane as the seat platform 124. The seat support member 126 is affixed to the outer ring 43 but can rotate about the axis of the seat support member 126.

The inner ring assembly 121 includes an inner ring 129 with an inner ring gear 131 located about the outside periphery of the inner ring 129. The inner ring 129 and the inner ring gear 131 are covered by an inner shroud 133. The inner unions 89, 95 are secured to the inner shroud 133.

The upper inner motor 91 and the lower inner motor 97 also hydraulic motors, are mounted on the inner shroud 133. The inner motors 91, 97 are located in the vicinity of one of the pair of inner unions 89, 95 but on opposite sides of the outer ring 43. The inner motor 91 is so designated as it is supplied by the upper union 47 and the lower inner motor 97 is so designated as it is supplied by the lower union 49. Hydraulic fluid is fed to the inner motors 91, 97 by a hydraulic line 135 which is mounted on opposite sides of the outer ring 43.

Each of the inner unions 89, 95 supplies only one inner motor 91, 97 accordingly, the inner unions 89, 91 each have one line for feeding hydraulic fluid to one of the inner motors 91, 97 and the other line for return of the hydraulic fluid.

The upper inner motor 91 has an upper inner motor gear 137 mounted on its shaft to engage and or rotate the inner ring gear 131. The lower inner motor 97 has a lower inner motor gear 139 mounted on its shaft to engage and rotate the inner ring gear 131. The upper inner motor 111 is located substantially half way around the inner ring gear 131 from the lower inner gear 139. The upper inner motor 91 is supplied with hydraulic fluid through the upper inner union 89 and the lower inner motor 97 is supplied with hydraulic fluid through the lower inner union 95. The upper inner motor gear 137 is paired with an upper inner idler gear 141. The lower inner motor gear 139 is paired with a lower inner idler gear 143. As with the support gear 103 the upper inner idler gear 141 and the lower inner idler gear 143 deter the inner ring gear 131 from moving away from the upper inner motor 91 and the lower inner motor 97.

A hydraulic distribution system is provided to provide hydraulic fluid to the upper motor 61 and the lower motor 65 and the upper support motor 77 and the lower support motor 81 and the upper inner motor 91, and the lower inner motor 97.

The hydraulic lines are physically mounted on the Pilot Seat Positioning Device in any convenient manner. The hydraulic power pack 99 produces pressurized hydraulic fluid. Preferably the hydraulic lines 145 extend from between the lower frame 19 and the base frame 17 to the four positions 27 and up a vertical post 25 to the upper journal as well as across the lower cross member 37 to the lower journal 41.

The hydraulic lines 145 are directly connected to the upper motor 61 and the lower motor 65. The upper motor 61 and the lower motor 65 do not themselves rotate therefore direct supply is possible. Since the hydraulic power pack 99 is preferably located between the base frame 17 and the lower frame 19, the lower motor 65 is readily connected. The hydraulic line 145 extends up one of the four vertical posts 25 directly to the upper motor 47.

Similarly, the hydraulic lines 145 extend up the outer ring 43 from the lower union 49 to the lower inner union 95. Similarly, hydraulic lines 145 extend down the outer ring 43 the upper union 47 to the upper inner union 89.

The rotation of the outer ring produces yaw. The movement of the support ring 101 produces pitch and the rotation of the inner ring 129 produces roll.

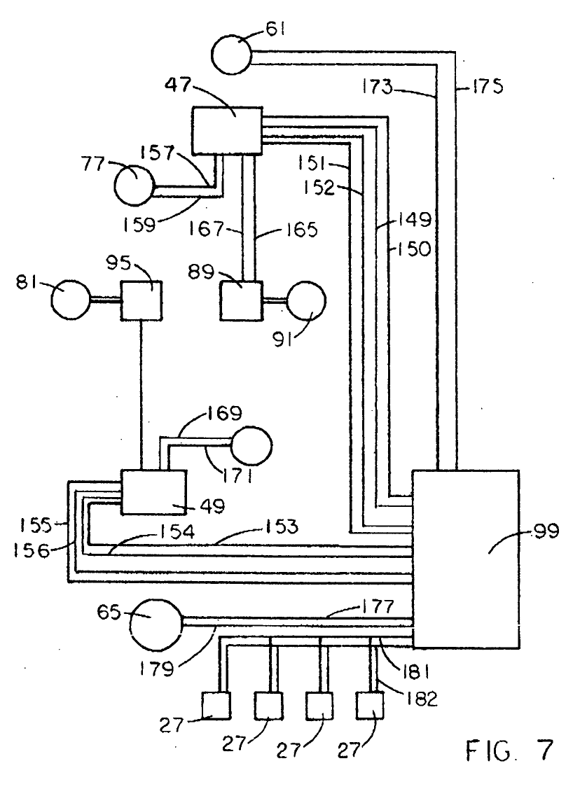

A schematic drawing of the hydraulic system of or the Pilot Seat Position Device is shown in FIG. 7. The hydraulic power pack 147 is the source of pressurized hydraulic fluid. The hydraulic lines 145 are shown extending to the various components of the hydraulic system which will now be described in greater detail. A first upper union line 149 and a second upper union line 150 and a third upper union line 151 and a fourth upper union line 152 connect the hydraulic power pack 99 to the upper union 47. The two upper union lines 149, 151 are necessary for a supply line and a return line. A first lower union line 153 and a second lower union line 154 and a third lower union line 155 and a fourth lower union line 156 connect the hydraulic power pack 147 to the lower union 49. The two lower union lines 153, 155 are necessary for a supply line and a return line. Hydraulic fluid from the upper union 47 is conveyed through a first upper support motor line 157 and a second upper support motor line 159, either of which can be used as a supply line and a return line, to the upper support motor 77. Similarly, hydraulic fluid from the lower union 49 is conveyed through a first lower support motor line 161 and a second lower support motor line 163, either of which can be used as a supply line and a return line, to the lower support motor 81.

Hydraulic fluid is conveyed from the upper union 47 to the upper inner motor 91 through the upper inner union 89 by a first upper inner motor line 165 and a second upper inner motor line 167 which together provide a supply line and a return line. Similarly, hydraulic fluid is conveyed from the lower union 49 to the lower inner motor 97 through the lower inner union 95 by a first lower inner motor line 169 and a second lower inner motor line 171 which together provide a supply line and a return line.

The upper motor 61 is supplied directly with hydraulic fluid from the hydraulic power pack 147 by a first upper motor line 173 and a second upper motor line 175. In the same manner, the lower motor 65 is supplied directly with hydraulic fluid from the hydraulic power pack 147 by a first lower motor line 177 and a second lower motor line 179. The first upper motor line and the second upper motor line provide a supply and return line for the upper motor 61 while the first lower motor line 177 and the second lower motor line 179 provide a supply line for the lower motor 65.

A first piston hydraulic line 181 and a second piston hydraulic line 182 from the hydraulic power pack supply, in parallel, the four pistons 27 located between the lower frame 19 and the upper frame 21.

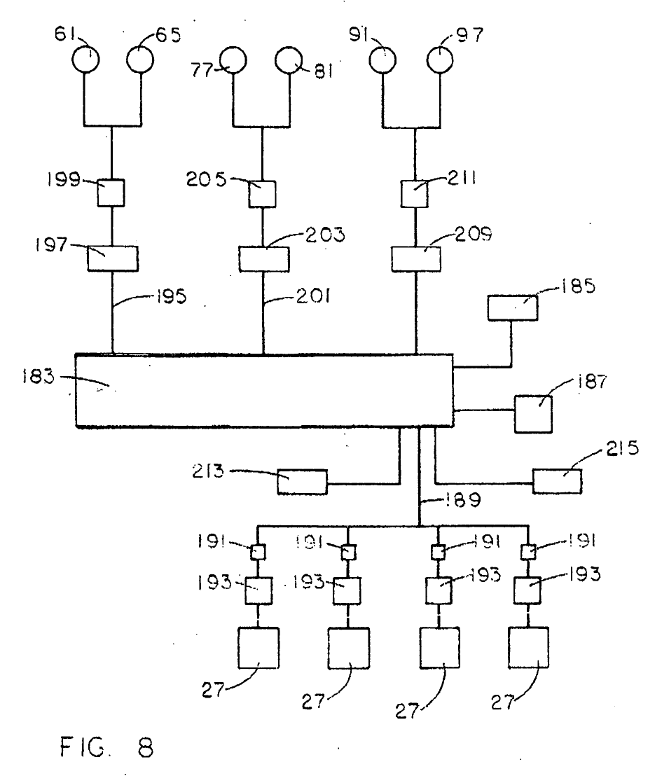

The electrical system, which controls the hydraulic system first previously described is shown in FIG. 8. The electrical system has a control processing unit 183 which is the source of control.

The central processing unit 183 activates an audio system and a video system. The central processing unit 183 supplies through a piston circuit 189, which include four piston amplifiers 191 and four piston solenoid valves 193 actuate, the four pistons 27. The piston amplifiers 193 increases the electrical power level supplied by the central processing unit 183. The four piston solenoid valves 193 can control the flow of hydraulic fluid to each of the four pistons 27.

The upper motor 61 and the lower motor 65 are controlled by a motor circuit 195 which includes an upper and lower motor amplifier 197 and an upper and lower motor solenoid 199. The upper motor 61 and the lower motor 65 are controlled together as they must act together, as is also the situation with the upper support motor 77 and the lower support motor 81 and also with the upper inner motor 91 and the lower inner motor 97.

The upper support motor 77 and the lower support motor 81 are controlled by the central processing unit 183 through a support circuit 201 which includes a support amplifier 203 which increases the electrical power level, and a support solenoid valve 205 which activates and deactivate the flow of hydraulic fluid to the upper support motor 77 and the lower support motor 81.

In the same fashion, an inner circuit 207 is provided between the central processing unit 183 and the upper inner motor 91 and the lower inner motor 97. The support circuit 201 includes an inner amplifier 209, to increase the electrical power level, and an inner solenoid 211 to activate and deactivate the flow of hydraulic fluid to the upper inner motor 91 and the lower inner motor 97.

A pilot input system 213 is provided for the pilot to enter data into the central processing unit 183. A general input system 215 supplies data from outside sources such as a remote flying aircraft to the central processing unit.

While a preferred embodiment is shown and described herein, it should be understood that the present disclosure is made by way of example only and that variations in the described Pilot Seat Positioning Device and its' uses are possible within the scope of the following claims, and a reasonable equivalency thereof, which claims we regard as our invention.

The claims are:

1. A Pilot Seat Positioning Device comprising:
a frame including an upper frame and a lower frame;
an upper journal mounted on the upper frame;
a lower journal located on the lower frame;
an outer ring mounted to rotate on the upper journal and the lower journal;
a support ring mounted to rotate on the outer ring, the support ring being located generally at right angles to the outer ring;
means for rotating the support ring;
an inner ring mounted to rotate on the outer ring within the support ring;
a seat platform extending across the inner ring mounted on the inner ring;
a seat support member located at right angles to the seat platform and in the same plane as the seat platform, the seat support member mounted to rotate in the support ring; and
a pilot seat mounted on the seat support member and across the support member.

2. The Pilot Seat Positioning Device according to claim 1 wherein;
the upper journal includes an upper union and an upper bevel gear mounted on the upper union and an upper casing enclosing the upper bevel gear, an upper motor having a shaft mounted on the upper casing, an upper motor gear mounted on the shaft of the upper motor, the upper motor gear engaging the upper bevel gear; and
the lower journal includes a lower union and a lower bevel gear mounted on the lower union and a lower casing enclosing the lower bevel gear, a lower motor having a shaft mounted on the lower casing, a lower motor gear mounted on the shaft of the lower motor, the lower motor gear engaging the lower bevel gear.

3. The Pilot Seat Positioning Device according to claim 1 wherein:
the frame includes a base located beneath the lower frame and four vertical posts between the upper frame and the lower frame and four pistons between the lower frame and the base; and
means to actuate the four pistons.

4. The Pilot Seat Positioning Device according to claim 1 wherein the support ring is slightly smaller than the outer ring and has an outside periphery, a support ring gear mounted on the outside periphery of the support ring, a support shroud covering the support ring and support ring gear.

5. The Pilot Seat Positioning Device according to claim 1 wherein;
the support ring has an outside periphery, a support ring gear mounted on the outside periphery of the support ring and a support shroud covering the support ring and support ring gear.

6. The Pilot Seat Positioning Device according to claim 1 wherein;
the support ring has an outside periphery, a support ring gear mounted on the outside periphery of the support ring and a support shroud covering the support ring and support ring gear; and
wherein the means for rotating the supporting ring includes:
an upper support motor mounted on the support shroud and having a shaft with an upper motor gear mounted on the shaft engaging the support ring gear; and
a lower support motor mounted on the support shroud and having a shaft with a lower motor gear mounted on the support ring gear.

7. A Pilot Seat Positioning Device comprising:
a frame including a base frame, a lower frame, and an upper frame, the frame further including four vertical posts extending between the lower frame and the upper frame, four pistons being located between the base frame.
an upper journal mounted on the upper frame, the upper journal including an upper union and an upper bevel gear mounted on the upper union, an upper casing enclosing the upper bevel gear, an upper motor mounted on the upper casing, the upper motor having a shaft, an upper motor gear mounted on the shaft of the upper motor, the upper motor gear engaging the upper bevel gear;
a lower journal mounted on the lower frame in the lower journal including a lower union and a lower bevel gear mounted on the lower union, a lower casing enclosing the lower bevel gear, a lower motor mounted on the lower casing, the lower motor having a shaft, a lower motor gear mounted on the shaft of the lower motor, the lower motor gear engaging the lower bevel gear, the upper journal and lower journal having a common centerline.
an outer ring mounted to rotate on the upper journal and the lower journal;
a support ring mounted to rotate on the outer ring, the support ring being located generally at right angles to the outer ring the support ring having an outside periphery, a support ring gear mounted on the support ring, a support shroud covering the support ring and support ring gear;
an upper support motor mounted on the support shroud and having a shaft with an upper motor gear mounted on the shaft, the upper motor gear engaging the support ring gear;
an upper support idler gear mounted on the support shroud, the upper support idler gear engaging the support ring gear, the upper motor gear and the upper idler gear being generally equally spaced on opposite sides of the centerline of the upper journal;
a lower support motor mounted on the support shroud, the lower support motor being hydraulic and having a shaft with a lower motor gears mounted on the shafts, the lower motor gear engaging the support ring gear;
a lower support idler gear mounted on the support shroud, the lower support idler gear engaging the support ring gear, the lower motor gear and the lower idler gear being generally equally spaced on opposite sides of the centerline of the lower journal, the lower support motor and the upper support motor being aligned in parallel but facing in opposite directions and being located on opposite sides of the centerline of the upper journal;
an inner ring assembly mounted to rotate in the outer ring within the support ring, the inner ring assembly including an inner ring with an outer periphery, an upper inner union and a lower inner union being mounted on opposite sides of the inner ring between the inner ring and the outer ring, the upper inner union and the lower inner union having a centerline, the inner ring assembly including an inner ring gear mounted on the outer periphery of the inner ring and an inner shroud covering the inner ring and inner ring gear;
an upper inner motor mounted on the inner shroud the upper inner motor being hydraulic and having a shaft with an upper inner motor gear engaging the inner ring gear;
an upper inner idler gear mounted on the inner shroud, the upper inner idler gear engaging the inner ring gear, the upper motor gear being generally equally spaced on opposite sides of the centerline, of the upper inner union and the lower inner union;
a lower inner motor mounted on the inner shroud, the lower inner motor being hydraulic and having a shaft with a lower inner motor gear mounted on the shaft, the lower inner motor gear engaging the inner ring gear;
a lower inner idler gear mounted on the inner shroud, the lower inner idler gear engaging the inner ring gear, the lower inner motor gear and the lower inner idler gear being generally equally spaced on opposite sides of the lower centerline of the upper inner union and the lower inner union. The upper inner motor and the lower ring motor being on opposite sides of the centerline of the upper inner union and the lower inner motor;
a seat platform extending across the inner ring mounted to the inner ring;
a seat support member located generally at right angles to the seat platform and in the same plane as the seat platform, the seat support member being mounted to rotate on the support ring;
a pilot seat mounted on the seat support member and across the support platform;
a hydraulic system including a hydraulic power pack and a hydraulic line for supplying hydraulic fluid to the upper motor and the lower union and from the upper union to the upper support motor and the lower support motor and to the upper inner union and the lower inner union and from the upper inner union to the upper inner motor and the lower inner motor; and
an electrical system to control the flow of hydraulic fluid including a central processing unit and solenoid valves.

8. The Pilot Seat Positioning Device according to claim 7 wherein the upper frame includes an upper cross member and the lower frame includes a lower cross member, the upper cross member having an upper semicircular cut and the lower cross member having a lower semicircular cut out.

9. The Pilot Seat Positioning Device according to claim 7 wherein the upper the upper journal is located generally in the center of the upper frame and the lower journal is located generally in the center of the lower frame.

10. A Pilot Seat Positioning Device according to claim 7 wherein the support gear has an outer periphery, a support ring gear being mounted on the periphery of the support ring.

11. A Pilot Seat Positioning Device according to claim 7 wherein the outer periphery an inner ring gear being mounted on the periphery of the inner ring.

12. A Pilot Seat Positioning Device comprising:
a frame, the frame being rectangular and including a base frame, a lower frame and an upper frame, the frame further including four vertical posts extending between the lower frame and the upper frame, four pistons being located between the base frame and the lower frame including an upper cross member and the lower frame including a lower cross member, the upper cross member having an upper semicircular cut out and the lower cross member having a semicircular cut out.
an upper journal located generally at the center of the upper frame in the semicircular cut out of the upper cross member, the upper journal including and an upper bevel gear, an upper casing enclosing the upper bevel gear, an upper motor mounted on the upper casing, the upper motor having a shaft, an upper motor gear mounted on the shaft of the upper motor, the upper motor gear engaging the upper bevel gear, the upper journal having a centerline;
a lower journal located generally at the center of the lower frame in the semicircular cut out of the lower cross member, the lower journal including a lower bevel gear mounted on the lower casing enclosing the lower bevel gear, a lower motor mounted on the lower casing, the lower motor having a shaft, a lower motor gear mounted on the shaft of the lower motor, the lower motor gear engaging the lower bevel gear, the lower journal having a centerline aligned with the centerline of the upper journal;
an outer ring mounted on the upper journal and the lower journal to rotate on the upper journal and the lower journal, the outer ring having the shape of a circle and having a diameter;
a support ring mounted to the outer ring, the support ring being located generally at right angles to the outer ring, the support ring being generally a complete circle and a diameter slightly smaller than the diameter of the outer ring, the support ring having an outside periphery, a support ring gear mounted on the outside periphery of the support ring, a support shroud covering the support ring and the support ring gear;
an upper support motor mounted on the support shroud, the upper support motor having a shaft with an upper motor gear mounted on the shaft, the upper motor gear engaging the support ring gear;
an upper support idler gear mounted on the support shroud, the upper support idler gear engaging the support ring gear, the upper motor gear and the upper idler gear being generally equally spaced on opposite sides of the centerline of the upper journal;
a lower support motor mounted on the support shroud, the lower support motor having a shaft with a lower motor gear mounted on the shaft, the lower motor gear engaging the support ring gear;
a lower support idler gear mounted on the support shroud, the lower support idler gear engaging the support ring gear, the lower motor gear and the lower idler gear being generally equally spaced on opposite sides of the centerline of the lower journal, the lower support motor and the upper support motor being aligned in parallel but facing in opposite directions and being located on opposite sides of the centerline of the upper journal and lower journal;
an inner ring assembly mounted to rotate on the outer ring within the support ring, the inner ring assembly including an inner ring with an outer periphery, the inner ring assembly including an inner ring gear mounted on the outer periphery of the inner ring and an inner shroud covering the inner ring and inner ring gear;
an upper inner motor mounted on the inner shroud, the upper inner motor having a shaft with an upper inner motor gear mounted on the shaft, the upper inner motor gear engaging the inner ring gear;
an upper inner idler gear mounted on the inner shroud, the upper inner idler gear engaging the inner ring;
a lower inner motor mounted on the inner shroud, the lower inner motor having a shaft with a lower inner motor gear mounted on the shaft, the lower inner motor gear engaging the inner ring gear;
a lower inner idler gear mounted on the inner shroud, the lower inner idler gear engaging the inner ring gear;
a seat platform extending across the inner ring and mounted on the inner ring;
a seat support member located generally at right angles to the seat platform and in the same plane as the seat platform, the seat support member being mounted to rotate on the support ring;
a pilot seat mounted on the seat support member and across the support platform; and
means for activating the upper motor and lower motor, the upper support motor and the lowest support motor and the upper inner motor and the lower inner motor.

13. A Pilot Seat Positioning Device according to claim 12 wherein the upper motor and lower motor, the upper support motor and the lower support motor and the upper inner motor and the lower inner motor are all hydraulic motors, and further including means for supplying hydraulic fluid to the upper motor and lower motor, the upper support motor and the lower support motor and the upper inner motor and the lower inner motor.

14. The Pilot Seat Positioning Device according to claim 12 wherein the upper motor and lower motor, the upper support motor and the lower support motor and the upper inner motor and the lower inner motor are all hydraulic motors and further including an upper union mounted in the upper journal and the lower union mounted in the lower journal and an upper inner union and a lower inner union mounted on opposite sides of the inner ring between the inner ring and the outer ring and means for supplying hydraulic fluid to and from the upper motor and to and from the upper union and to and from the upper union to and from the upper support motor and to and from the upper inner union and to and from the upper inner motor and for supplying hydraulic fluid to and from the lower motor and to and from the lower union and to and from the lower support motor and the lower inner union and to and from the lower motor.

15. A Pilot Seat Positioning Device comprising:
a frame, the frame including a base frame, a lower frame further including four vertical posts extending between the lower frame and the upper frame, four pistons being located between the base frame and the lower frame, the upper frame including an upper cross member and the lower cross member including a lower cross member, the upper cross member having an upper semicircular cut out and the lower cross member having a semicircular cut out;
an upper journal located generally at the center of the upper frame in the semicircular cut out of the upper cross member, the upper journal including an upper union and an upper bevel gear mounted on the upper union, an upper casing enclosing the upper bevel gear, an upper motor mounted on the upper casing the upper motor being hydraulic and having a shaft, an upper motor gear mounted on the shaft, an upper motor gear mounted on the shaft of the upper motor gear engaging the upper bevel gear, the upper journal having a centerline;
a lower journal located generally at the center of the lower frame in the semicircular cut out of the lower cross member, the lower journal including a lower union and a lower bevel gear mounted on the lower union, a lower casing enclosing the lower bevel gear, a lower motor mounted on the lower casing, the lower motor being hydraulic and having a shaft, a lower motor gear mounted on the shaft of the lower motor, the lower motor gear engaging the lower bevel gear, the lower journal having a centerline;
an outer ring mounted on the upper journal and the lower journal to rotate on the upper journal and the lower journal, the outer ring having the shape of a circle and having a diameter;
an upper support idler gear mounted on the support shroud, the upper support idler gear engaging the support ring gear, the upper motor gear and the upper idler gear being generally equally spaced on opposite sides of the centerline of the upper journal;
a support ring mounted to rotate on the outer ring, the support ring being located generally at right angles to the outer ring, the support ring being generally a complete circle and having a diameter slightly smaller than the diameter of the outer ring, the support ring having an outside periphery, a support ring gear mounted on the outside periphery of the support ring, a support shroud covering the support ring and support ring gear;
a lower support motor mounted on the support shroud, the lower support motor being hydraulic and having a shaft with a lower motor gear engaging the support ring gear;
a lower support idler gear mounted on the support shroud, the lower support idler gear engaging the support ring gear, the lower motor gear and the lower idler gear being generally equally spaced on opposite sides of the centerline, of the lower journal, the lower support motor and the upper support motor being aligned in parallel but facing in opposite directions and being located on opposite sides of the centerline of the upper journal and the lower journal;
an inner ring assembly mounted to rotate on the outer ring within the support ring, the inner ring assembly including an inner ring with an outer periphery, an upper inner union and a lower union being mounted on opposite sides of the inner ring between the inner ring and the outer ring, the upper inner union and the lower inner union having a centerline, the inner ring assembly including an inner ring gear mounted on the outer periphery of the inner ring and an inner shroud covering the inner ring and inner ring gear;
an upper inner motor mounted on the inner shroud the upper inner motor being hydraulic and herein a shaft with a upper inner motor gear mounted on the shaft, the upper inner motor gear engaging the inner ring gear;
an upper inner idler gear mounted on the inner shroud, the upper inner idler gear engaging the inner ring gear, the upper motor gear and the upper idler gear being generally equally spaced on opposite sides of the centerline of the upper inner union and the lower inner union;
a lower inner motor mounted on the inner shroud, the lower inner motor being hydraulic and having a shaft with a lower inner motor gear mounted on the shaft, the lower inner motor gear engaging the inner ring gear;
a lower inner idler gear mounted on the inner shroud, the lower inner idler gear engaging the inner ring gear, the lower inner motor gear and the lower inner idler gear being generally equally spaced on opposite sides of the lower centerline of the upper inner union and the lower inner union, the upper inner motor and the lower ring motor being on opposite sides of the centerline of the upper inner union and the lower inner motor;
a seat platform extending across the inner ring and mounted to the inner ring;
a seat support member located generally at right angles to the seat platform and in the same plane as the seat platform, the seat support member being mounted to rotate on the support ring;
a pilot seat mounted on the seat support member and across the support platform;
a hydraulic system including a hydraulic power pack located between the lower frame and the base frame and further including hydraulic lines for supplying hydraulic fluid to the upper motor and lower motor and to the upper union and the lower union and from the upper union to the upper support motor and the lower support motor and to the upper inner union and the lower inner union and the lower inner union to the upper inner union to the upper inner motor and the lower inner motor; and
an electrical system to control the flow of hydraulic fluid including a central processing unit and solenoid valves.

16. A Pilot Seat Positioning Device according to claim 15 wherein the frame is rectangular.
